(19) United States
(12) Patent Application Publication
(10) Pub. No.: US 2026/0055734 A1
(43) Pub. Date: Feb. 26, 2026

(54) SYSTEMS AND METHODS FOR DETERMINING BROADCAST ENGINE TORQUE VALUES FOR INTERNAL COMBUSTION ENGINES

(71) Applicant: Cummins Inc., Columbus, IN (US)

(72) Inventors: Siddarth Ashokkumar, Pune (IN); Mayur H. Borate, Pune (IN); Srinivas Kumar Mulukutla, Pune (IN)

(21) Appl. No.: 19/278,134

(22) Filed: Jul. 23, 2025

(30) Foreign Application Priority Data
Aug. 20, 2024 (IN) 202441062710

(51) Int. Cl. F02D 41/00

(52) U.S. Cl. CPC F02D 41/0097; F02D 2200/06; F02D 2200/1002; F02D 2200/101; F02D 2200/602

(57) ABSTRACT

The accuracy of the torque broadcast values from an engine control unit is the subject of regulatory requirements for automotive systems since the broadcast torque values are used in calculations to determine regulatory compliance. A system is disclosed herein that includes a powertrain including an engine configured to output torque to a driveline, and an electronic control system operatively coupled with the powertrain. The electronic control system is configured to determine a broadcast engine torque value that is corrected for fueling error between torque based fuel values determined during operation of the engine and the fuel amount that is provided to the engine. The correction for fueling error improves the accuracy of the torque broadcast values.

### CROSS-REFERENCE TO RELATED APPLICATION

The present application claims priority to India patent application No. 202441062710 filed on Aug. 20, 2024, which is incorporated herein by reference.

### FIELD OF THE INVENTION

The present disclosure relates to systems and methods for operating internal combustions, and more particularly for determining broadcast engine torque values during operation of internal combustion engines.

### BACKGROUND

It is desirable for the torque amount that is broadcast by the engine control unit correspond to the actual engine torque produced within a certain accuracy, such as within 10% of the actual engine torque, in order to comply with regulatory requirements. Multiple applications on the engine control unit/transmission control unit use broadcast engine torque values to control operation of various aspects of the engine and/or transmission. Therefore, accuracy of the broadcast engine torque values is of particular importance in controlling emissions, maximizing fuel economy, and optimizing performance of the engine and components connected thereto.

Existing methods suffer from a number of drawbacks and shortcomings including those respecting accuracy and reliability, particularly over time. For example, some approaches may determine the torque broadcast value using commanded fueling values and reverse look-up tables that map the commanded fueling values against an indicated engine torque. The engine brake torque that is used as the broadcast engine torque value is then calculated by subtracting friction torque and pumping torque from the indicated engine torque.

However, these and other approaches do not account for fueling system variation, such as injector drift and/or system level noises, in determining the broadcast engine torque value. The variation in actual injected fuel quantity may impact the commanded fueling values and the accuracy of the broadcast engine torque value. There remains a significant unmet need for the unique apparatuses, methods, systems, and techniques disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created and that the invention includes and protects such alterations, modifications, and further applications of the example embodiments as would occur to one skilled in the art.

### SUMMARY

Embodiments include unique systems for determining broadcast engine torque values during operation of internal combustion engines that account for fueling errors. Other embodiments include methods for determining broadcast engine torque values during operation of internal combustion engines that account for fueling errors. Further embodiments, forms, objects, features, advantages, aspects, and benefits shall become apparent from the following description and drawings.

### BRIEF DESCRIPTION OF THE FIGURES

FIG. 1 is a schematic diagram illustrating certain aspects of an example internal combustion engine system.

FIG. 2 is a schematic diagram illustrating certain aspects of example controls for the internal combustion engine system of FIG. 1.

FIG. 3 is a schematic diagram illustrating certain aspects of an example method for operating the internal combustion engine system of FIG. 1.

### DETAILED DESCRIPTION OF EXAMPLE EMBODIMENTS

Embodiments of the present application include a system and method that can improve broadcast engine torque values accuracy by compensating for fueling errors between torque based fuel values determined during operation of the internal combustion engine (also referred to herein as “engine”) and the fueling amount that is provided to the engine. Torque based fuel values are determined for the engine in response accelerator based torque values and friction torque values. Corrected fuel values are determined based on fueling errors between the torque based fuel values and the fuel amounts provided to the engine in response to the torque based fuel values. The broadcast engine torque values are based on the corrected fuel values.

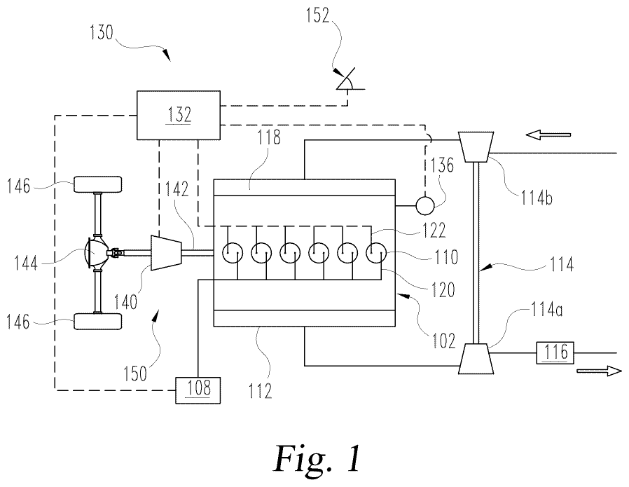

FIG. 1 illustrates a schematic block diagram of an exemplary system 100 that includes a powertrain 101, such as might be employed in a vehicle. Powertrain 101 includes an internal combustion engine 102 and a transmission 140 that is connected to engine 102 with an output shaft 142. System 100 as illustrated also includes a differential 144 and ground engaging wheels 146. Transmission 140, differential 144, and ground engaging wheels 146 may be considered components of a driveline 150 which is operatively coupled with output shaft 142 of engine 102, such as with a clutch and/or torque converter. Transmission 140 may be a manual transmission, automatic transmission, automated manual transmission, or any other suitable transmission.

In the illustrated embodiment, system 100 is a vehicle system propelled by ground engaging wheels 146 which are provided as rear wheels; however, in other embodiments, front-wheel drive, four-wheel drive, and all-wheel drive approaches are contemplated. In some embodiments, system 100 is a form of on-road bus, delivery truck, a service truck, or the like. In other embodiments, system 100 may be a different type of vehicle, including other types of on-road or off-road vehicles. In still other embodiments, system 100 may be a marine vehicle (boat/ship) or another type of vehicle. In yet other embodiments, rather than a being provided in a vehicle type of system, powertrain 101 is applied to other applications and systems, such as an engine-driven generator (a gen-set), a pumping system, or another powertrain system.

Engine 102 includes an intake 104 and an exhaust 106. Engine 102 receives fuel from one or more fuel sources 108. Engine 102 of system 100 can be structured to operate with a variety of types of fuels that are delivered from the fuel source 108, including, for example, liquid fuels such as diesel fuel, gasoline, ethanol etc. and/or gaseous fuels such as hydrogen, natural gas, bio-gas, methane, propane, producer gas, field gas, liquefied natural gas, compressed natural gas, landfill gas, gaseous fuel, and/or any combination thereof, among other fuels.

According to an exemplary embodiment, engine 102 includes an engine block that may define at least a portion of one or more cylinders 110. For example, according to certain embodiments, the engine 102 can include six cylinders 110 in an in-line arrangement as illustrated in FIG. 1. However, engine 102 may have any different number of cylinders 110, as well as cylinders in a variety of different arrangements. Additionally, each cylinder 110 is sized to accommodate the slideable displacement of a piston (not shown) along at least a portion of the cylinder 110 such that the pistons may reciprocate between a top-dead-center position and a bottom-dead-center position. Each of the cylinders 110, its respective piston and cylinder head, form a combustion chamber. Further, at least a portion of the forces generated by the slideable displacement of the piston along at least a portion of the cylinder during combustion events in the combustion chamber are transmitted to a mechanical drive system For example, the pistons are typically operably coupled to output shaft 142 of engine 102 to convert the reciprocal movement of the pistons of the engine 102 into rotational movement.

The cylinders 110 are in selective fluid communication with the intake 104 such that a charge flow from intake 104 can be delivered to the combustion chamber. The cylinders 110 are also in selective fluid communication with the exhaust 106 such that exhaust gases produced by combustion of fuel(s) in the combustion chambers can be delivered through an exhaust manifold 112 of the exhaust 106. The exhaust 106 can include and/or be coupled to a variety of different components, such as, for example, one or more turbines 114a of turbocharger 114, as well as an aftertreatment system 116. Engine system 100 may also include an exhaust gas recirculation system (not shown), such as a high pressure and/or a low pressure exhaust gas recirculation system. However, embodiments without a turbocharger and/or exhaust gas recirculation system are also contemplated.

Operation of engine 102 can include the delivery of charge flow and fuel to the combustion chambers of the engine 102. According to certain embodiments, fuel can be injected into each cylinder 110 via a corresponding one of the fuel injectors 120. Other embodiments contemplate gaseous fuel is fumigated into the charge flow upstream of the cylinders 110 of engine 102, such as, for example, upstream or downstream of the compressor 114b of turbocharger 144 at intake 104, at the intake manifold 118, and/or cylinder ports, or can be fumigated into the charge mixture in-cylinder. Combustion of the air-fuel mixture can be initiated with igniters 122, such as spark plugs, which create a spark at each of the cylinders 110. The delivery of the charge mixture, the fuel, and/or the ignition of the charge and fuel mixture in the combustion chambers may be, at least in part, electrically controlled by an electronic control system 130 of the engine system 100, as discussed further below.

In a particular embodiment, engine 102 is a spark-ignited internal combustion engine and combusts fuel that is provided to the combustion chambers of engine 102 in response to a net torque value of the engine. The net torque value is determined from an accelerator based torque value and a friction torque value, and is used to determine a torque based fuel value for fucling of engine 102. The torque based fuel value is a commanded fuel amount determined from a lookup table or fuel control algorithm, as discussed further below. Operating parameters for the fuel injectors 120, such as injection pressure and on-times, are calibrated to output the commanded fuel amount that corresponds to the torque based fuel value derived from the lookup table or fuel control algorithm.

Due to system level noise, injector variation between different engine platforms, injector specific fueling errors, and/or fuel injector drift and other fuel system changes over time, the fuel amount that is actually provided by fuel injectors 120 during operation of engine 102 may differ from the determined or calculated fuel amount that corresponds to the torque based fuel values derived from lookup tables and/or algorithms. Control system 130 is configured to determine a broadcast engine torque value that accounts for the fueling error between the fuel amount that is provided to the engine in response to the torque based fuel value and the determined or calculated fuel amount for the torque based fuel value. The fueling error between the fuel amount that is provided to the engine and the determined or calculated fuel amount for the corresponding torque based fuel value can create inaccurate broadcast engine torque values when the broadcast engine torque values are based on the torque based fuel values.

Control system 130 includes an electronic controller or electronic control unit (ECU) 132 configured to control various operational aspects of system 100, including powertrain 101, engine 102, transmission 140, driveline 150, fuel injection events, and/or broadcast engine torque values, among other operations. The electronic controller 132 can be implemented in a number of ways. Further, the electronic controller 132 can execute operating logic that defines various control, management, and/or regulation functions. The operating logic may be in the form of one or more microcontroller or microprocessor routines stored in a non-transitory memory, dedicated hardware, such as a hardwired state machine, analog calculating machine, various types of programming instructions, and/or other forms as would occur to those skilled in the art.

Electronic controller 132 may be provided as a single component, or a collection of operatively coupled components, and may comprise digital circuitry, analog circuitry, or a hybrid combination of both of these types. When of a multi-component form, electronic controller 132 may have one or more components remotely located relative to the others in a distributed arrangement. Electronic controller 132 can include multiple processing units arranged to operate independently, in a pipeline processing arrangement, in a parallel processing arrangement, or the like. In one embodiment, electronic controller 132 includes several programmable microprocessing units of a solid-state, integrated circuit type that are distributed throughout the internal combustion engine system 100 that each includes one or more processing units and non-transitory memory.

For the depicted embodiment, electronic controller 132 includes a computer network interface to facilitate communications using standard Controller Area Network (CAN) communications or the like among various system control units. It should be appreciated that the depicted modules or other organizational units of electronic controller 132 refer to certain operating logic performing indicated operations that may each be implemented in a physically separate controller of electronic controller 132 and/or may be virtually implemented in the same controller. Electronic controller 132 may include one or more organizational units or circuits that may be implemented in hardware and/or as computer instructions on a non-transient computer readable storage medium and may be distributed across various hardware or computer based components.

Example and non-limiting implementation elements of control system 130 and/or organizational units of electronic controller 132 include, for example, sensors such as accelerator pedal position sensors for accelerator pedal 152, engine sensors 136 (such as speed, torque and/or coolant temperature sensors), and/or fuel system sensors for fuel system 108 (such as fuel system pressure sensors, fuel injector on-time sensors, fuel injector on/off count sensors, etc.) These and/or other sensors may provide any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements. The sensors 136 and/or any other sensors may be physical sensors, virtual sensors, and/or combinations of physical and virtual sensors.

Electronic controller 132 and/or any of its constituent processors/controllers may include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or functional components as would occur to those skilled in the art to perform the desired communications.

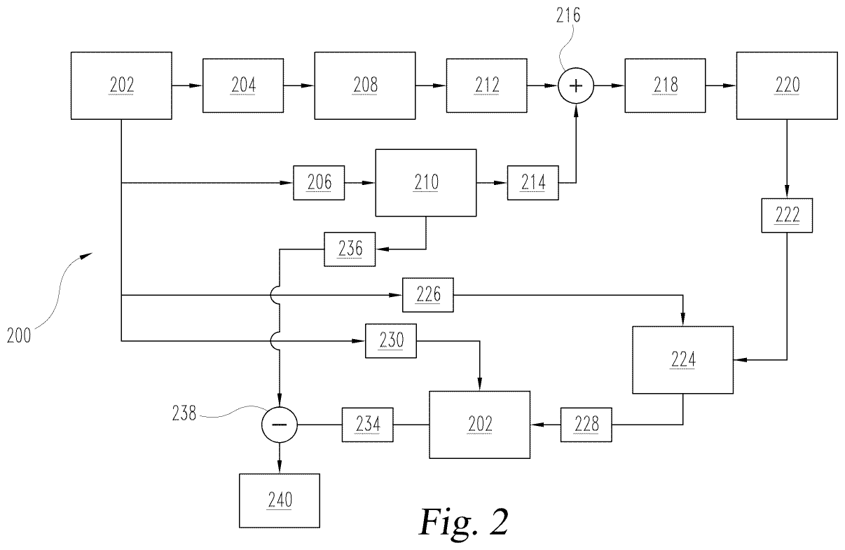

System 100 is an example of a system including a powertrain with an engine configured to output torque to a driveline, a fuel system operable to fuel the engine to produce the output torque, and an electronic control system operatively coupled with the powertrain and the fuel system and configured to determine a broadcast engine torque value that accounts for a fueling error between the torque based fuel value and a fuel amount that is provided to the engine in response to the torque based fuel value. In certain embodiments, system 100 may be so configured using one or more aspects of the controls described in connection with FIG. 2.

With reference to FIG. 2, there are illustrated example controls 200 which may be implemented in one or more components of an electronic control system such as ECS 130 of system 100, electronic controller 132, and/or another electronic control system operatively coupled with powertrain 101 including engine 102 and fuel system 108. Controls 200 may, for example, be implemented in one or more integrated-circuit based (e.g., microprocessor-based or microcontroller-based) electronic control units such as electronic controller 132 or one or more other electronic control units.

Controls 200 include a duty cycle inputs block 202 (also referred to as block 202). Block 202 is configured to receive and/or process outputs from sensors and other components of system 100. Block 202 is further configured to provide a first sets of inputs 204 to a first lookup table 208 and a second set of inputs 206 to a second lookup table 210.

In an embodiment, first set of inputs 204 include an engine speed of engine 102 and an accelerator pedal position of accelerator pedal 152. First lookup table 208 is an accelerator based torque lookup table which maps engine speeds and accelerator pedal positions to accelerator based torque values. Controls 200 are configured to provide an accelerator based torque value output 212 from first lookup table 208 based on the engine speed and accelerator pedal position provided by first set of inputs 204.

In an embodiment, second set of inputs 206 include the engine speed of engine 102 and a coolant temperature of engine 102. Second lookup table 208 is a friction torque lookup table which maps engine speeds and coolant temperatures to friction torque values. Controls 200 are configured to provide a friction torque value output 214 from second lookup table 210 based on the engine speed and coolant temperature provided by second set of inputs 206.

Controls 200 are configured to sum the accelerator based torque value output 212 and the friction torque value output 214 at operator 216. The summation of accelerator based torque value output 212 and friction torque value output 214 is provided from operator 216 as a net torque value output 218. In an embodiment, net torque value output 218 is a net torque value to be produced by engine 102 based on accelerator pedal position, engine speed, and coolant temperature.

Controls 200 provide the net torque value output 218 to a third lookup table 220. In an embodiment, third lookup table 220 is a torque to fuel lookup table that maps net torque values to torque based fuel values in order to determine a fuel command/amount that satisfies the net torque value. In an embodiment, the torque based fuel values in third lookup table 220 are empirically determined based on the design of the fuel injectors 120, fuel system 108, and operating characteristics thereof. Controls 200 provides a torque based fuel value output 222 from third lookup table 220 based on the net torque value output 218.

Controls 200 provide torque based fuel value output 222 to fueling error compensation block 224, also referred to as block 224. In an embodiment, one or more duty cycle inputs 226 are also provided as feedback to fueling error compensation block 224. Fueling error compensation block 224 is configured to determine a corrected fuel value output 228 based on a fueling error between the lookup table fuel amount provided by torque based fuel value output 222 and a fuel amount provided to the engine 102 in response to the torque based fuel value output 222. The fuel amount provided to the engine 102 can vary from the lookup table fuel amount that corresponds to the torque based fuel value due to, for example, variations between injectors actually used versus injectors used to empirically determine the lookup table torque based fuel values, injector drift over time, and/or system level noise, for example.

Controls 200 provide the corrected fuel value output 228 and a duty cycle engine speed input 230 to a fourth lookup table 232. In an embodiment, fourth lookup table 232 is a fuel to torque lookup table that maps fuel values and engine speeds to engine torque values. Controls 200 determine a corrected engine torque value output 234 based on mapping the corrected fuel value output 228 and engine speed input 230 in fourth lookup table 232.

Corrected torque value output 234 is provided to operator 238 along with a friction torque value output 236. Controls 200 broadcast a broadcast engine torque value output 240 based on a difference between the corrected engine torque value output 234 and the friction torque value output 236 determined by operator 238.

Broadcast engine torque value output 240 is an example of a broadcast engine torque value that has been adjusted to compensate for fueling error and is based and a fueling amount provided to the engine rather than a commanded or torque based fuel value. In certain embodiments, the broadcast torque value output 240 may be a net brake torque value indicating torque at a defined driveline location such as an interface between engine 102 and a transmission component (e.g., torque at the input side of a transmission clutch).

Broadcast engine torque value output 240 may be provided to components of electronic control system 130 to control operation of aftertreatment system 116 to reduce emissions and/or one or more components of driveline 150 in response to the broadcast engine torque value. For example, broadcast engine torque value outputs 140 may be provided to a transmission control component, for example, by broadcasting the broadcast engine torque value output 140 over a communications network or otherwise providing it to a transmission control component of electronic control system 130. Broadcast engine torque value outputs 140 may be provided to one or more components of electronic control system 130 to control one or more additional or alternative components of the driveline 150 in response to the broadcast engine torque value, for example, powertrain control features such as traction control devices and systems, stability control devices and systems, vehicle-level control systems and features such as adaptive and/or predictive cruise control systems (e.g., smart cruise), automated vehicle control systems and features, autonomous vehicle control systems and features, and other control systems and features whose operation is responsive to engine torque.

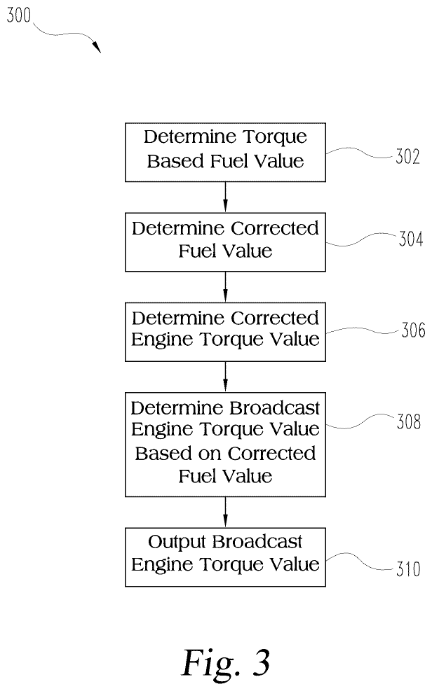

Referring to FIG. 3, an exemplary procedure or method 300 of determining a broadcast torque value is illustrated. Method 300 includes an operation 302 to determine the torque based fuel value. The torque based fuel value can be determined during operation of engine 102 in response an accelerator based torque value and a friction torque value. For example, the torque based fuel value can be derived from third lookup table 220 as discussed above.

Method 300 continues at operation 304 to determine a corrected fuel value. The corrected fuel value can be based on a fueling error between the torque based fuel value and a fuel amount that is provided to the engine in response to the torque based fuel value. For example, the corrected fuel value can be determined from fueling error compensation block 224 as discussed above, such as from a sensor feedback that provides an indication or measurement of the fueling error or an estimate of the fueling error determined empirically.

Method 300 continued at operation 306 to determine a corrected engine torque value. The corrected engine torque value can be based on the corrected fuel value that compensates for fueling error. In an embodiment, the corrected fuel value along with engine speed are input to fourth lookup table 232 as discussed above to determine the corrected engine torque value. Fourth lookup table 232 is a fuel to torque lookup table that maps fuel values and engine speed to determine engine torque values.

Method 300 continues at operation 308 to determine a broadcast engine torque value. The broadcast engine torque value is based on a difference between the corrected engine torque value and the friction torque value. Method 300 continues from operation 308 at operation 310 to output the broadcast engine torque value for use by, for example, electronic control system 130.

In an embodiment, the torque based fuel value is determined by inputting a net torque value that is based on a sum of the accelerator based torque value and the friction torque value into a torque-to-fuel look-up table, such as third lookup table 220, that maps net engine torque values with fuel values. In an embodiment, the accelerator based torque value is determined by inputting engine speed and accelerator pedal position to an accelerator based torque table, such as first lookup table 208, that maps engine speeds and accelerator pedal positions with accelerator based torque values. In an embodiment, the friction torque value is determined by inputting engine speed and coolant temperature to a friction torque table, such as second lookup table 210, that maps engine speeds and coolant temperatures with friction torque values.

In an embodiment, the fuel amount provided to engine 102 that is used to determine the fueling error is based on feedback pressures and on-times during injection events of one or more fuel injectors 120 of fuel system 108 that provides fuel to engine 102. For example, fueling error compensation block 224 of controls 200 and/or method 300 can include a closed loop fueling compensation algorithm that is configured to estimate the injected fuel amount for each instantaneous injection event of fuel injectors 120 using fuel injector on-time and injection pressure dynamic fuel injection curve equations.

The estimate of the actual fuel injection amount based on injection pressures and injector on-times automatically adapts to changes in the injector and other fuel system components over time, system level noise, and/or component variations. The torque based fuel value is adjusted for the fueling error determined from the estimate of the actual fuel injection amount to provide the corrected fuel value. The corrected fuel value is then used in a fuel to torque lookup table to determine a more accurate corrected engine torque value that is compensated for fueling error and used with the friction torque value to determine the broadcast engine torque value.

In an embodiment, the fuel amount provided to engine 102 that is used to determine the fueling error is determined based on an estimate of drift in fueling from one or more fuel injectors 120 of fuel system 108 that provides fuel to engine 120 and a total number of injection counts for the one or more fuel injectors 120. For example, fueling error compensation block 224 of controls 200 and/or method 300 includes data obtained from testing fuel injector hardware to learn the maximum shift in injector fueling on both the high side and low side over the usable life of the injector. The usable life of the injector is associated with a maximum number of injections.

During operation of system 100, controls 200 tracks the number of injections to have current count of total injections. The current drift in injector fuel is estimated by a ratio of the current count of total injections with the maximum number of injections for the usable life of the injector. The maximum shift in injector fueling is then prorated by this ratio to provide an estimate of the actual fuel injection amount compensated for changes in the injector and fuel system components over time. The torque based fuel value is adjusted for the fueling error determined from the estimate of the actual fuel injection amount to provide the corrected fuel value. The corrected fuel value is then used in a fuel to torque lookup table to determine a more accurate corrected engine torque value that is compensated for fueling error and used with the friction torque value to determine the broadcast engine torque value.

The disclosed controls and methods include a number of elements referred to as a block, an operator, a lookup table, an operation, or like terms. It shall be appreciated that such terms connote structural features that may be configured and implemented in a number of forms. In certain forms, such features may be provided by configuring one or more integrated circuit-based control units and/or other circuitry to execute instructions stored in one or more non-transitory memory media. The controls and methods described herein are also described as determining or configured to determine one or more values or parameters. It shall be appreciated that such references encompass determinations by a variety of techniques including, for example, calculation, computation, estimation, measuring, sensing, table lookup operations, and combinations of the foregoing and other determination techniques.

The controls and methods described herein are also described as determining, predicting, or configured to determine or predict one or more values or parameters. It shall be appreciated that such references encompass determinations and predictions of values or parameters that may are not directly observable (e.g., because they will occur in the future, even if very shortly in the future, or because measurement of current conditions is not possible or practicable) by a variety of techniques including, for example, calculation, computation, estimation, measuring, sensing, table lookup operations, and combinations of the foregoing and other determination techniques. The controls described herein are also described as accounting for a number of effects. It shall be appreciated that such references encompass operations including adjusting, correcting, modifying, or otherwise determining (directly or indirectly) a parameter or value with improved accuracy or reduced error.)

A number of aspects of the present disclosure are contemplated. For example, one aspect is a system that includes a powertrain including an engine configured to output torque to a driveline, a fuel system configured to provide fuel to the engine in response to an accelerator pedal position, and an electronic control system operatively coupled with the powertrain and the fuel system. The electronic control system is configured to determine a torque based fuel value during operation of the engine in response an accelerator based torque value and a friction torque value; determine a corrected fuel value based on a fueling error between the torque based fuel value and a fuel amount provided to the engine in response to the torque based fuel value; determine a corrected engine torque value based on the corrected fuel value; determine a broadcast engine torque value based on a difference between the corrected engine torque value and the friction torque value; and output the broadcast engine torque value.

In an embodiment, the electronic control system is configured to determine the corrected engine torque value by inputting the corrected fuel value into a fuel-to-torque look-up table that maps fuel values and engine speed with engine torque values.

In a further embodiment, the electronic control system is configured to determine the torque based fuel value by inputting a net torque value that is based on the accelerator based torque value and the friction torque value into a torque-to-fuel look-up table that maps net engine torque values with fuel values.

In a further embodiment, the electronic control system is configured to determine the accelerator based torque value by inputting engine speed and accelerator pedal position to an accelerator based torque table that maps engine speeds and accelerator pedal positions with accelerator based torque values.

In a further embodiment, the electronic control system is configured to determine the friction torque value by inputting engine speed and coolant temperature to a friction torque table that maps engine speeds and coolant temperatures with friction torque values.

In a further embodiment, the net torque value is a sum of accelerator based torque value and the friction torque value.

In an embodiment, the electronic control system is configured to determine the fuel amount provided to the engine based on a feedback pressure and an on-time from one or more fuel injectors of the fuel system.

In a further embodiment, the electronic control system is configured to determine the fuel amount provided to the engine for each injection event of the one or more fuel injectors of the fuel system.

In an embodiment, the electronic control system is configured to determine the fuel amount provided to the engine based on an estimate of drift in fueling from one or more fuel injectors of the fuel system.

In a further embodiment, the estimate of drift is based on a total number of injection counts for the one or more injectors.

In an embodiment, the broadcast engine torque value is a net brake torque value indicating torque at an interface between the engine and a transmission component.

In an embodiment, the electronic control system is further configured to control the powertrain in response to the broadcast engine torque value.

Another aspect of the disclosure is a method for determining broadcast engine torque values. The method includes determining a torque based fuel value during operation of an engine in response an accelerator based torque value and a friction torque value; determining a corrected fuel value based on a fueling error between the torque based fuel value and a fuel amount provided to the engine in response to the torque based fuel value; determining a corrected engine torque value based on the corrected fuel value; determining a broadcast engine torque value based on a difference between the corrected engine torque value and the friction torque value; and outputting the broadcast engine torque value.

In an embodiment, the corrected engine torque value is determined by inputting the corrected fuel value into a fuel-to-torque look-up table that maps fuel values and engine speed with engine torque values.

In a further embodiment, the torque based fuel value is determined by inputting a net torque value that is based on a sum of the accelerator based torque value and the friction torque value into a torque-to-fuel look-up table that maps net engine torque values with fuel values.

In a further embodiment, the accelerator based torque value is determined by inputting engine speed and accelerator pedal position to an accelerator based torque table that maps engine speeds and accelerator pedal positions with accelerator based torque values.

In a further embodiment, the friction torque value is determined by inputting engine speed and coolant temperature to a friction torque table that maps engine speeds and coolant temperatures with friction torque values.

In an embodiment, the fuel amount provided to the engine is based on feedback pressures and on-times during injection events of one or more fuel injectors of a fuel system that provides fuel to the engine.

In an embodiment, the fuel amount provided to the engine is determined based on an estimate of drift in fueling from one or more fuel injectors of a fuel system that provides fuel to the engine and a total number of injection counts for the one or more fuel injectors.

In an embodiment, the engine receives fuel from a fuel system and outputs torque to a driveline in response to an accelerator pedal position.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A system for determining broadcast engine torque values, the system comprising:
a powertrain including an engine configured to output torque to a driveline;
a fuel system configured to provide fuel to the engine in response to an accelerator pedal position; and
an electronic control system operatively coupled with the powertrain and the fuel system, the electronic control system configured to:
determine a torque based fuel value during operation of the engine in response an accelerator based torque value and a friction torque value;
determine a corrected fuel value based on a fueling error between the torque based fuel value and a fuel amount provided to the engine in response to the torque based fuel value;
determine a corrected engine torque value based on the corrected fuel value;
determine a broadcast engine torque value based on a difference between the corrected engine torque value and the friction torque value; and
output the broadcast engine torque value.

2. The system according to claim 1, wherein the electronic control system is configured to determine the corrected engine torque value by inputting the corrected fuel value into a fuel-to-torque look-up table that maps fuel values and engine speed with engine torque values.

3. The system according to claim 2, wherein the electronic control system is configured to determine the torque based fuel value by inputting a net torque value that is based on the accelerator based torque value and the friction torque value into a torque-to-fuel look-up table that maps net engine torque values with fuel values.

4. The system according to claim 3, wherein the electronic control system is configured to determine the accelerator based torque value by inputting engine speed and accelerator pedal position to an accelerator based torque table that maps engine speeds and accelerator pedal positions with accelerator based torque values.

5. The system according to claim 4, wherein the electronic control system is configured to determine the friction torque value by inputting engine speed and coolant temperature to a friction torque table that maps engine speeds and coolant temperatures with friction torque values.

6. The system according to claim 5, wherein the net torque value is a sum of accelerator based torque value and the friction torque value.

7. The system according to claim 1, wherein the electronic control system is configured to determine the fuel amount provided to the engine based on a feedback pressure and an on-time from one or more fuel injectors of the fuel system.

8. The system according to claim 7, wherein the electronic control system is configured to determine the fuel amount provided to the engine for each injection event of the one or more fuel injectors of the fuel system.

9. The system according to claim 1, wherein the electronic control system is configured to determine the fuel amount provided to the engine based on an estimate of drift in fueling from one or more fuel injectors of the fuel system.

10. The system according to claim 9, wherein the estimate of drift is based on a total number of injection counts for the one or more injectors.

11. The system according to claim 1, wherein the broadcast engine torque value is a net brake torque value indicating torque at an interface between the engine and a transmission component.

12. The system according to claim 1, wherein the electronic control system is further configured to control the powertrain in response to the broadcast engine torque value.

13. A method for determining broadcast engine torque values, the method comprising:
determining a torque based fuel value during operation of an engine in response an accelerator based torque value and a friction torque value;
determining a corrected fuel value based on a fueling error between the torque based fuel value and a fuel amount provided to the engine in response to the torque based fuel value;
determining a corrected engine torque value based on the corrected fuel value;
determining a broadcast engine torque value based on a difference between the corrected engine torque value and the friction torque value; and
outputting the broadcast engine torque value.

14. The method according to claim 13, wherein the corrected engine torque value is determined by inputting the corrected fuel value into a fuel-to-torque look-up table that maps fuel values and engine speed with engine torque values.

15. The method according to claim 14, wherein the torque based fuel value is determined by inputting a net torque value that is based on a sum of the accelerator based torque value and the friction torque value into a torque-to-fuel look-up table that maps net engine torque values with fuel values.

16. The method according to claim 15, wherein the accelerator based torque value is determined by inputting engine speed and accelerator pedal position to an accelerator based torque table that maps engine speeds and accelerator pedal positions with accelerator based torque values.

17. The system of claim 16, wherein the friction torque value is determined by inputting engine speed and coolant temperature to a friction torque table that maps engine speeds and coolant temperatures with friction torque values.

18. The method according to claim 13, wherein the fuel amount provided to the engine is based on feedback pressures and on-times during injection events of one or more fuel injectors of a fuel system that provides fuel to the engine.

19. The method according to claim 13, wherein the fuel amount provided to the engine is determined based on an estimate of drift in fueling from one or more fuel injectors of a fuel system that provides fuel to the engine and a total number of injection counts for the one or more fuel injectors.

20. The method according to claim 13, wherein the engine receives fuel from a fuel system and outputs torque to a driveline in response to an accelerator pedal position.
